(19) United States
(12) Patent Application Publication
(10) Pub. No.: US 2006/0066624 A1
(43) Pub. Date: Mar. 30, 2006

(54) Method and system for generating per-pixel error bounds for a rendered image

(75) Inventors: Alexander Stevenson, Bellevue, WA (US); Federico Schliemann, Kirkland, WA (US)

Correspondence Address: LAW OFFICES OF ALBERT S. MICHALIK;C/O MICROSOFT CORPORATION, 704 - 228TH AVENUE NE, SUITE 193, SAMMAMISH, WA, 98074, US

(73) Assignee: Microsoft Corporation, Redmond, WA (US)

(21) Appl. No.: 10/956,013

(22) Filed: Sep. 30, 2004

(51) Int. Cl. G06T 1/60

(52) U.S. Cl. 345/530

(57) ABSTRACT

A method and system measuring the correctness of rendered images. A reference renderer generates a reference image from data describing the image. A tolerance buffer is generated that includes a tolerance for a pixel representing a portion of the reference image. If a renderer renders the pixel outside the tolerance for the pixel, the renderer is deemed to have rendered the pixel incorrectly. If the renderer renders the pixel within the tolerance, the renderer is deemed to have rendered the pixel correctly.

### FIELD OF THE INVENTION

The invention relates generally to computers, and more particularly to images rendered by computers.

### BACKGROUND

Many modern computers use displays intensively to display images. An image is a graphical representation that is rendered by a renderer, such as a graphics card. Numerical precision errors, algorithmic mistakes, and other factors may cause an image to be displayed differently on different renderers. In the past, a rendered image was considered “correct” if the rendered image had at least a selected percentage of pixels that were identical with a reference image rendered by a reference renderer. This measure of “correctness” measures the differences between a reference image and a rendered image, not whether the rendered image was rendered correctly. What is needed is a better method and system for measuring the correctness of rendered images.

### SUMMARY

Briefly, the present invention provides a method and system for measuring the correctness of rendered images. A reference renderer generates a reference image from data describing the image. A tolerance buffer is generated that includes a tolerance for a pixel representing a portion of the reference image. If a renderer renders the pixel outside the tolerance for the pixel, the renderer is deemed to have rendered the pixel incorrectly. If the renderer renders the pixel within the tolerance, the renderer is deemed to have rendered the pixel correctly.

In one aspect, the tolerance buffer may include a tolerance for each pixel comprising the reference image. If the renderer renders each pixel in the reference image within the tolerance associated therewith, the renderer is deemed to have rendered the image correctly. If the renderer renders one or more pixels outside the tolerances associated therewith, the renderer is deemed to have rendered the image incorrectly.

In another aspect, the tolerance for each pixel may be generated by determining the maximum error bound associated with each pixel. This maximum error bound may be affected by any of a number of numerical precision and other errors.

Other aspects will become apparent from the following detailed description when taken in conjunction with the drawings, in which:

### BRIEF DESCRIPTION OF THE DRAWINGS

FIG. 1 is a block diagram representing a computer system into which the present invention may be incorporated;

FIG. 2 is a block diagram that illustrates a triangle placed on a grid of pixels in accordance with various aspects of the invention;

FIGS. 3A-3B are block diagrams that are helpful in illustrating various errors that may occur while rendering an image in accordance with various aspects of the invention; and

FIGS. 4-7 are flow diagrams that generally represent actions that may occur to determine if a rendered image is within tolerance in accordance with various aspects of the invention.

### DETAILED DESCRIPTION

Exemplary Operating Environment

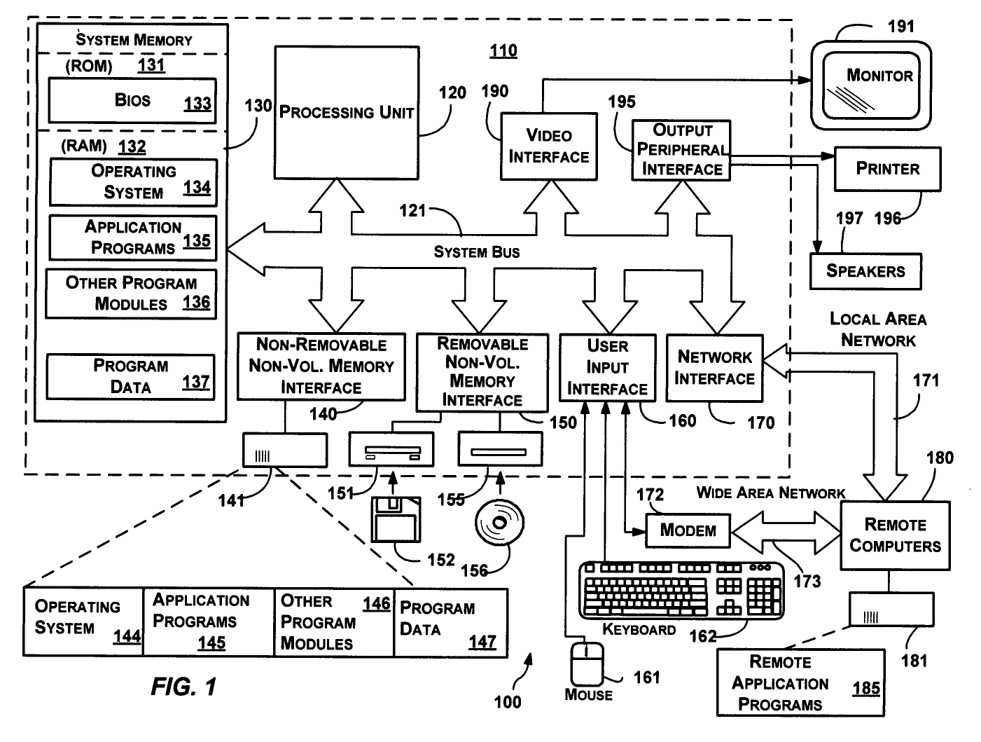

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Measuring Correctness in Rendered Images

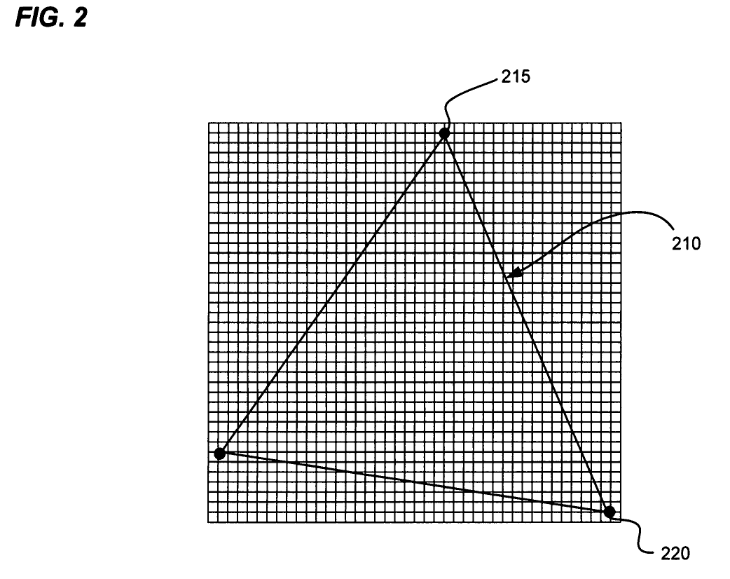

FIG. 2 is a block diagram that illustrates a triangle placed on a grid in accordance with various aspects of the invention. A display may be divided into pixels arranged in a grid such as the one shown surrounding the triangle 210 and may include other pixels to the edges of the display. Typically, a computer may cause each pixel on the display to display a color independently of the colors displayed in other pixels displayed on the display.

To display the triangle 210, the display may cause pixels included within the triangle 210 to display one or more colors. Although the triangle 210 is shown having darkened circles on each of its vertices, these darkened circles may not be displayed when the triangle is rendered. Likewise, the borders of the triangle 210 may not be displayed as continuous lines but rather by causing discrete pixels that lie inside the border of the triangle 210 to display colors.

Many errors may occur when an image is rendered by a particular renderer. These errors may be related to lighting, texturing, and transformation. Some of these errors are a result of numerical precision errors such as rounding or truncation that occurs as the renderer renders the image. For example, a rounding error may cause a particular pixel to have a certain color because it is determined that the pixel is part of a shape while full accuracy would dictate that the pixel have another color because it is not part of the shape.

Other errors may occur as a result of an algorithmic mistake in which the algorithm a renderer uses is flawed in some manner or another. For example, a renderer may improperly implement a line drawing algorithm or may cause certain pixels to have certain values, but only if the pixels are in certain locations on the display.

Some errors are tolerable. For example, a pixel that lies on the edge of a white triangle having a black background may be white or black depending on whether it is determined that the pixel lies within or without the triangle. In this case, it may be equally acceptable to have the pixel display black or white because of the numerical precision of the renderers which will render the image. There may be, on the other hand, no tolerance for error for a rendering a pixel that lies in the center of the triangle as the pixel should display white on every renderer. If such a pixel displays anything but white, this may indicate that a renderer is unacceptably flawed and needs to be fixed.

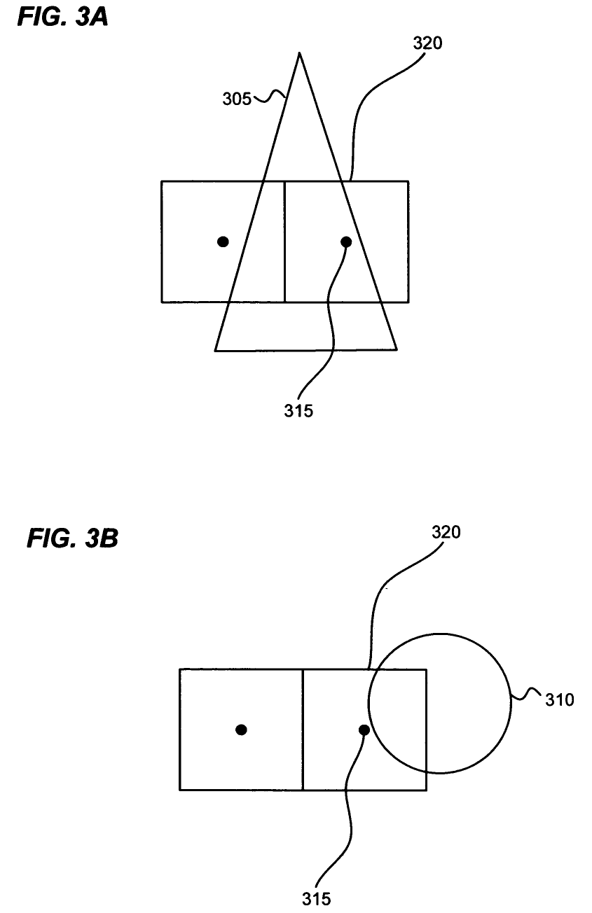

FIGS. 3A-3B are block diagrams that are helpful in illustrating various errors that may occur while rendering an image in accordance with various aspects of the invention. It will be understood, however, that the potential errors discussed in conjunction with FIGS. 3A and 3B are exemplary and that other errors may occur and be detected without departing from the spirit or scope of the present invention.

FIG. 3A is a block diagram that shows an enlarged view of two pixels and a triangle in accordance with various aspects of the invention. Many renderers use triangles or other shapes in rendering images. Pixels located within a shape may be caused to display certain colors while pixels outside of the shape may be caused to display a default color such as black.

An error in rendering a shape may occur in determining whether a pixel, or more accurately the point at which the pixel is sampled, lies within the mathematical boundary defined by the shape. Frequently (and as assumed below for clarity), pixels are sampled at their center; so it is this point which is used to determine whether each pixel is inside a shape. It will be understood, however, that pixels may be sampled at a variety of other points which may then be used to determine whether each pixel is inside a shape without departing from the spirit or scope of the invention.

When a shape, such as a triangle 305, encloses a pixel center, such as a pixel center 315, a pixel (i.e., pixel 320) associated with the pixel center 315 may be caused to display a color associated with the shape. If the pixel center 315 is determined not to lie within the triangle 305, the pixel may be caused to display a default color (unless the pixel is included in another shape that is to be displayed).

This type of error may be referred to as a per-pixel error. Other per-pixel errors include, for example, errors due to geometry transformation imprecision, per-pixel lighting errors, and “z-buffer aliasing” artifacts. Geometry transformation imprecision occurs when a pixel (or the shape including the pixel) is transformed through some operation from one location to another location. For example, a triangle may be rotated or viewed from a different perspective which may cause a per-pixel error of various pixels through numerical precision.

Per-pixel lighting errors may result from imprecise lighting calculations. For example, referring to FIG. 3B, a light may have a cone 310 that either encompasses a pixel center 315 or does not encompass the pixel center 315. If the light source is relatively bright and focused, and close to the pixel center, there is a significant chance that numerical imprecision will cause the pixel center 315 to be encompassed or not. If a renderer determines that the pixel center 315 is encompassed by the cone 310, then the pixel 315 may be caused to display a bright color. If a renderer determines that the pixel center 315 is not encompassed by the cone 310, then the pixel 315 may be caused to display a default color, such as black. This difference in possible final color values, from a bright color to black, may be the values added to the tolerance buffer to account for this potential error.

Even though a display typically shows images on a two-dimensional surface, displaying the objects in the image may involve three-dimensional analysis in which objects may overlap. Each pixel from each object may be placed in a z ordering that indicates which pixel should be displayed if the pixel overlaps a pixel from another object. A z-buffer aliasing artifact may occur when two shapes are at almost the same distance from a point of view. For example, if two triangles lie almost on top of each other, it is possible that portions of both triangles may be determined by a renderer as being closer to the point of view. If one triangle is black and another triangle is white, a renderer may render an image that includes portions from both triangles that sharply contrast with each other.

In each of the examples described in FIGS. 3A and 3B, one renderer may determine one outcome for a pixel that is close to a boundary while another renderer may determine another outcome. The difference in outcomes, however, may be as stark as a pixel that goes from black to white. Because of the imprecise nature of discrete representation of an image, either outcome may fall within an acceptable tolerance for rendering the pixel.

In an embodiment of the invention, there may be a tolerance allotted for each pixel in an image. The tolerance may be calculated based on allowable truncating and rounding errors. If a rendered pixel is within a tolerance from its associated reference pixel, the rendered pixel may be considered acceptable. If a rendered pixel is not within a tolerance from the reference pixel, the rendered pixel may be considered unacceptable.

To determine acceptable and unacceptable image renderings, a tolerance buffer may be associated with a frame buffer (sometimes called a bitmap of an image) wherein there is a one-to-one correspondence between representations of pixels in the frame buffer (sometimes referred to simply as pixels) and tolerances for pixels in the tolerance buffer. A pixel in the frame buffer may have a set of values (sometimes referred to as a pixel vector) associated with different attributes of the pixel such as color and transparency channels. For example, in one implementation, a pixel in the frame buffer may have values that range between 0 and 255 for each attribute of transparency, red, green, and blue.

Likewise, a tolerance vector in the tolerance buffer may have a value associated with each value of a pixel vector for a pixel in the frame buffer. If a reference pixel in the frame buffer of a reference image has a pixel vector having attributes [transparency, red, green, blue] of C_{REF}=[A,R,G,B] and an associated tolerance vector of an associated tolerance buffer has values of T₀=[ε_{A}, ε_{R}, ε_{G}, ε_{B}], then a rendered pixel, C_{REN} that corresponds to the reference pixel of the rendered image is correct if for each value of the associated vectors, C_{REF}−T₀≦C_{REN}≦C_{REF}+T₀. Another way of representing this condition is that if the absolute value of (C_{REN}−C_{REF})≦T₀, for each value of the associated vectors, then the rendered pixel is correct.

Note that if any of the values of a rendered pixel vector is outside of the tolerance of its associated value of the tolerance vector, then the pixel is incorrect. In other words, if the absolute difference between a value of the rendered pixel vector and its associated value in the reference pixel vector is greater than the associated value of the tolerance vector, then the rendered pixel is incorrect. For example, if C_{REF}=[255,20,30,40], T₀=[0,5,3,2], and C_{REN}=[255,20,30,37], then C_{REN} is incorrect as the difference between the blue values (i.e., the absolute value of 40−37=3) is greater than the blue tolerance value (i.e., 2), even though all of the other values match.

Further note that if T₀ is set to [0,0,0,0] for a particular pixel that a rendered pixel for that pixel will be incorrect if its pixel vector is any different from the pixel vector of the corresponding pixel in the reference image. In pixel representations in which the maximum any value of a pixel vector may be is 255, if T₀ is set to [255,255,255,255], then a rendered pixel is essentially ignored with respect to correctness. That is, if T₀ is set to a maximum value for a particular pixel, it does not matter how a renderer renders the particular pixel.

A pixel may be associated with a tolerance vector having a maximum tolerance, if it is substantially equally likely that the pixel may be rendered in any one of two ways. For example, a pixel (e.g., pixel 320) with a pixel center that is right by a border of the triangle 305 may be included or not included in the triangle depending on how accurate the rendering engine is. Furthermore, it may be determined that either including or not including the pixel is a correct rendering as the pixel center 315 is so close to the border of the triangle 305. If, however, the triangle is white, C=[255,255,255,255], and the pixel will be left at a default value of black, i.e., C=[255,0,0,0] if it is not included in the triangle, then there is a stark difference between the outcome of determining whether the pixel center is within the triangle or without.

Furthermore, a pixel may be associated with a tolerance vector that has a maximum tolerance for fewer than all of the values of the tolerance vector. For example, a red triangle may have a reference color C_{REF}=[255,255,0,0] and may have a side very close to a center of a pixel. To allow the pixel to be colored red or not at all, a tolerance vector for the pixel may be set to [0,255,0,0]. Then, an un-tolerated rendering error occurs if the pixel is rendered in any color other than red. Likewise, if the triangle consists of a combination of two colors, the tolerance vector of a pixel close to the edge of the triangle may have two color values with maximum tolerance.

A tolerance vector for a pixel may accumulate tolerances from many sources. For example, three cones of light may each be close to encircling a pixel. One cone may have a color of [255,20,0,0], another cone may have a color of [255,0,30,0], and another cone may have a color of [255,0,0,40]. To account for the possibility that acceptable rounding or truncating errors may cause the pixel to be encircled by all three lights or none of the lights a tolerance vector associated with the pixel may be set to [0,20,30,40].

If the same pixel was also close to the boundary of a triangle having a color of [255,10,30,80], the tolerance vector may be set to [0,20,30,80] to tolerate the possibility that the pixel is encircled by all three light sources and is part of the triangle.

In general, a tolerance vector may represent an upper bound of the error that may be expected at a rendered pixel associated with the pixel. If the rendered pixel is outside this bound, either the renderer has made an unacceptable mistake or an error that was not accounted for in the tolerance vector occurred. If the former condition exists, the mistake of the renderer may be found and fixed. If the later condition exists, the error may be added to the tolerance vector.

Another set of errors that may affect the tolerance of a pixel or set of pixels are per-vertex errors. In general, the tolerance vector of these pixels may be computed in the same manner in which colors are modified in the reference image. For example, if an operation related to per-vertex errors changes color values in a pixel by certain percentages, the color values in the tolerance vector may also be modified by the percentages.

For example, vertex 215 of triangle 210 of FIG. 2 may have an error of 255 while vertex 220 may have an error of 0. When the triangle 210 is viewed from a normal that is perpendicular to the plane containing the three vertices of the triangle, the per-vertex error may be distributed to tolerance vectors associated with pixels included in the triangle by interpolating the error between each pair of vertices. For example, a point halfway between vertex 215 and vertex 220 may have an error of 127.

When, however, the triangle 210 is viewed from a perspective other than the one described above, error may be distributed to tolerance vectors associated with pixels included in the triangle by interpolating the error between each pair of vertices in a perspective-correct manner. In this perspective-correct manner, the error vector for each pixel included in the triangle may be modified in the same way the pixels are modified when doing perspective-correct Gourad shading.

In other words, the tolerance buffer may be treated as an image that is modified in the same way that a frame buffer of a reference image is modified. If a pixel in the frame buffer is overwritten, its associated tolerance vector in the tolerance buffer is overwritten. If a pixel is blended in the frame buffer (e.g., through transparency effects), the values in an associated tolerance vector in the tolerance buffer may be blended in the same way. If a vertex having a pixel vector of [255,40,60,80] and an associated tolerance vector of [0,10,20,30] causes a pixel to have a pixel vector of [255,20,30,40] though perspective-correct shading, then the associated tolerance vector may be modified in the same manner to [0,5,10,15]. The tolerance buffer may be viewed as another image wherein the color values of each pixel represents tolerance. The same transformations that apply to the frame buffer may be applied to the tolerance buffer.

Another per-vertex error is per-vertex lighting error. This error may also be caused by numerical precision issues in calculating the cone of a spot-light, the range of a local light, or the transformation of a vertex normal. In any case, the tolerance vector at a vertex may then be blended in a perspective correct way across the tolerance vectors associated with pixels on adjacent faces to the vertex. Once the error is blended across adjacent faces it can be added to the per-pixel error of the pixels which make up those faces.

If a pixel is partially or totally transparent, one or more pixels that lie beneath the pixel (in the z ordering) may influence the final display values of the displayed pixel. For example, in one implementation, a transparency value of 255 may represent that a pixel is not transparent (i.e., opaque) while a transparency value of 0 may represent that a pixel is completely transparent. If a pixel is partially transparent, the tolerance vector associated with the pixel may be comprised of tolerances associated with the pixel and any pixels that show through the pixel. For example, if a pixel has a pixel vector of [127,50,30,20] and a pixel that shows through the pixel has a pixel vector of [255,0,0,0], the resulting pixel may have a pixel vector of [255,25,15,10]. Similarly, if the foreground pixel would generate a tolerance vector of [0,40,20,10] and a pixel behind the pixel would generate a tolerance vector of [0,0,0,0], the resulting tolerance vector may be [0,20,10,5].

Some renderers may perform operations typically performed on a per-vertex basis on a per-pixel basis. For example, lighting may be performed on a per-pixel basis rather than a per-vertex basis. In this case, the per-vertex corrections described above for lighting may not be done. Rather, the tolerance may be computed or adjusted as each pixel is changed based on a per-pixel operation. Similarly, in other typical per-vertex operations that are instead done on a per-pixel basis, the tolerance may be computed on a per-pixel basis.

Some errors may result from texture that is placed on an image. Texture allows pictures to be placed on triangles or other shapes used to draw the image. The texture may have sharp boundaries that lie close to pixel centers. As a result, on different renderers, small numerical imprecision may result in drastically different color values at a given pixel location. To deal with this error, a low-pass filter may be applied to the texture before applying the texture to the image and computing the tolerance buffer. By removing the high frequencies from the textures, the tolerance buffer may exclude errors caused by texturing inaccuracy.

Some renderers may have programmable logic that allows a programmer to determine how objects are rendered. If it is determined that steps within the programmable logic introduce error that could cause multiple outcomes based on numerical precision of the renderer, the tolerance buffer may take into account these errors by having specified tolerances related to the steps.

The error sources described above are exemplary and are not intended to limit the error sources that may be used to compute a tolerance buffer. Indeed, any number of sources of errors may adjust the tolerance vector associated with particular pixel without departing from the spirit or scope of the invention.

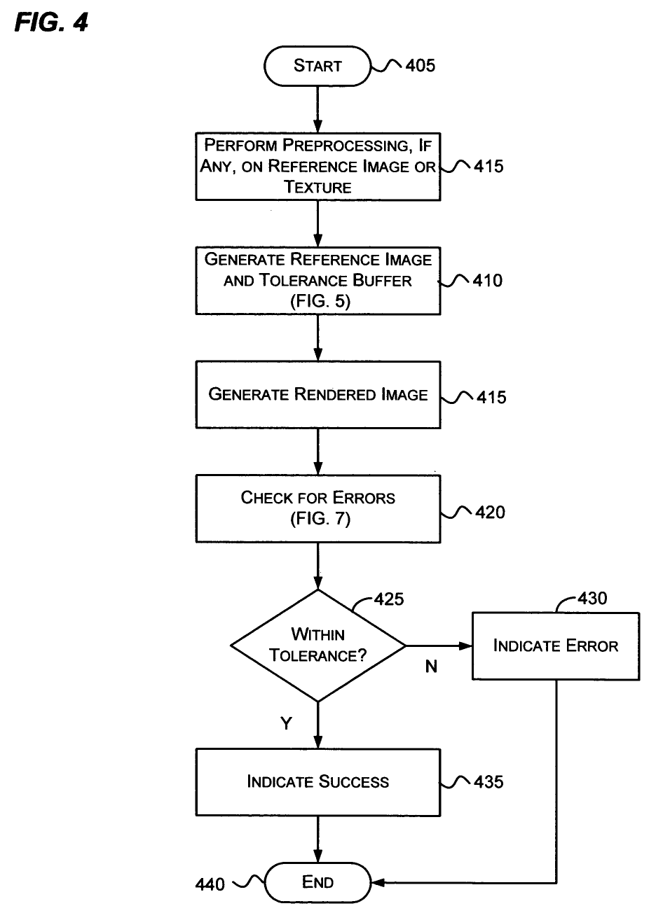

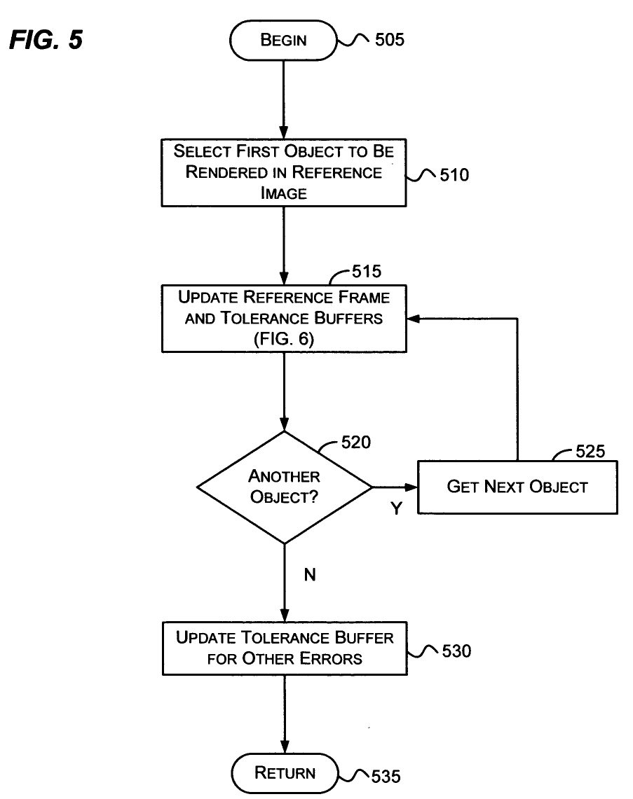

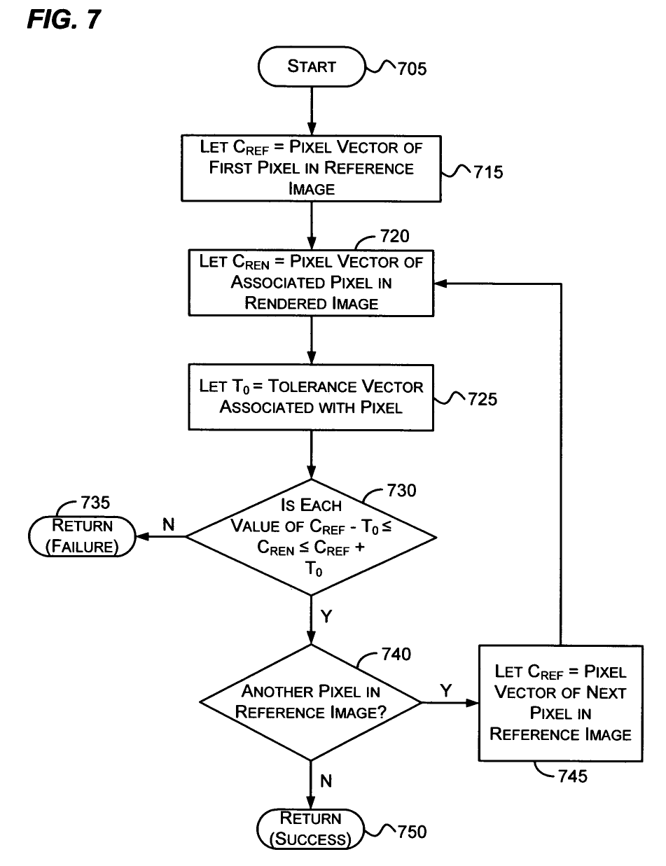

FIGS. 4-7 are flow diagrams that generally represent actions that may occur to determine if a rendered image is within tolerance in accordance with various aspects of the invention. At block 405, the process begins. At block 415, preprocessing, if any, is performed. For example, a low-pass filter may be applied to a texture before placing the texture in the reference image. At block 410, the reference image and tolerance buffer are generated as described in more detail in conjunction with FIG. 5. At block 415, the image is rendered by a renderer that is being tested. At block 420, the rendered image is checked for errors as described in more detail in conjunction with FIG. 7. If each pixel within the rendered error is within tolerance, success may be indicated at block 435; otherwise, the rendered image does not pass and an error may be indicated at block 430. At block 440, the process ends.

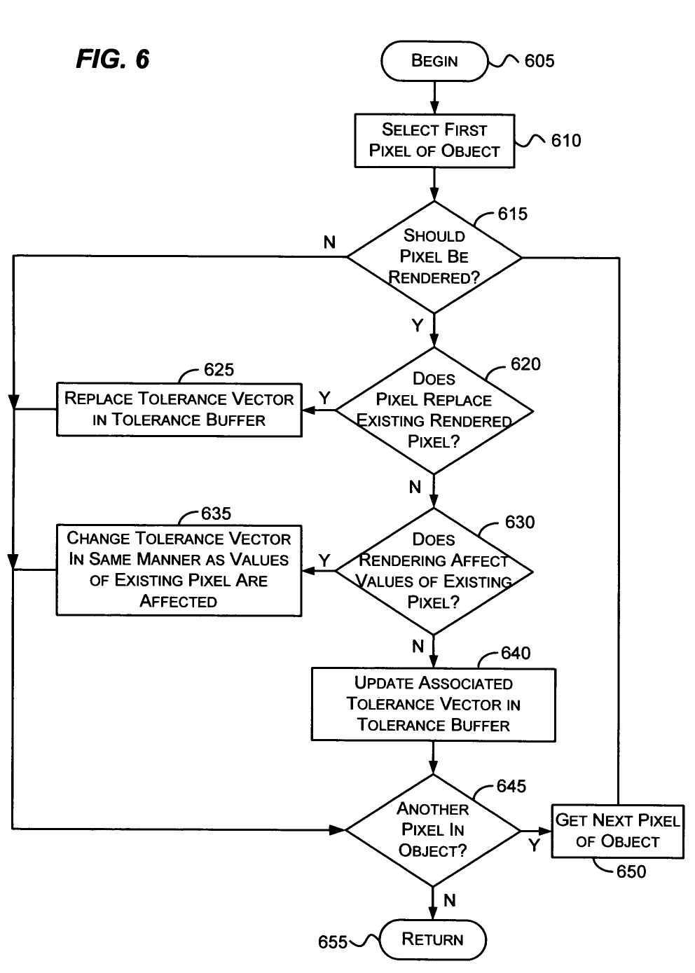

Turning to FIG. 5, the first object to be rendered in the reference image is selected at block 510. An object includes anything that is to be rendered in the reference image and may include a shape, texture, lighting, a line, a pixel, or a set of pixels, any combination of the above, and the like. At block 515, the reference frame and tolerance buffers are updated as described in more detail in conjunction with FIG. 6. At block 520, a determination is made as to whether there is another object to be rendered. If so, processing continues at block 525; otherwise processing continues at block 530. At block 525, another object to render is obtained.

At block 530, the tolerance buffer may be updated for any other errors. For example, a particular renderer may render pixels on the edge of a display with color values of two less than they should be. If a pixel on the edge of the display is set to black, no adjustment may be needed. Otherwise, to avoid indicating that the renderer is flawed, the values of tolerance vectors associated with pixels on the edge of the display may be increased by two.

At block 535, the process returns to the calling process.

Turning to FIG. 6, the first pixel of the object is selected at block 610. At block 610, a determination is made as to whether the pixel should be rendered. A pixel for an object may not be rendered, for example, if it is beneath another opaque pixel of another object that has already been rendered. The reference renderer may decide to render a pixel if it expects any conceivably correct renderer may do so, since in this diagram the tolerance buffer is not updated unless the pixel is rendered. If the pixel should be rendered, processing continues at block 620; otherwise, processing continues at block 645.

At block 620, a determination is made as to whether the pixel replaces another already-rendered pixel. For example, a pixel from an object that is further from a point of view may be drawn before a pixel that is from an object that is closer to the point of view. The two pixels may also map to the same location on the display or frame buffer. If so, the pixel from the closer object overwrites the further away pixel. Similarly, the tolerance vector associated with the pixel is overwritten by the tolerances computed for the new pixel as indicated in block 625.

At block 630, a determination is made as to whether the rendering will affect one or more values of any existing pixel. For example, the rendering of a pixel for an object that is beneath a partially transparent pixel of another object may adjust values of a pixel vector as described previously. If this occurs, the tolerance vector associated with the existing pixel is changed in the same manner (e.g., by the same percentage or percentages) as how the values of the pixel vector are changed in the frame buffer as indicated in block 635.

At block 640, a tolerance vector is updated based on the rendered pixel. Each time the pixel is affected by yet another object, the tolerance vector may again be updated to include the tolerance associated with the rendering of a pixel associated with the other object. For example, if multiple light sources may encompass a pixel center, the tolerance vector associated with the pixel may be updated as each light source is rendered.

At block 645, a determination is made as to whether another pixel is in the object. If so, processing branches to block 650; otherwise, processing branches to block 655 at which the process returns to the calling process.

Turning to FIG. 7, the process outlined therein steps through each of the pixels in the reference image (blocks 715, 740, and 745), finds an associated pixel in the rendered image (block 720), and an associated tolerance vector associated with the pixel (block 725). If any rendered pixel is outside the tolerance vector, a code is returned that indicates that the rendered image is not within tolerance of the reference image (block 730). Otherwise, a code is returned that indicates that the reference image is within tolerance of the reference image (block 750).

While examples have been shown with pixel vectors having four attributes (i.e., transparency and red, green, and blue channels), it will be recognized that aspects of the invention may be applied to pixel vectors having more or fewer attributes without departing from the spirit or scope of the invention. Furthermore, it will be recognized that aspects of the invention may be applied to attributes other than the four attributes mentioned above. In addition, while aspects of the invention have been described in vectors that may be represented with 8 bits per attribute, it will be readily recognized that more or less than 8 bits per attribute may be employed without departing from the spirit or scope of the invention.

It will be recognized that there are advantages associated with various aspects of the present invention. For example, whereas some rendering detection techniques are only able to detect whether a certain number of pixels are incorrect, aspects of the present invention may be used to detect whether each pixel is rendered within tolerance.

As can be seen from the foregoing detailed description, there is provided an improved method and system for measuring the correctness of rendered images. While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer-readable medium having computer-executable instructions, comprising:
generating a reference buffer from data associated with an image, the reference buffer having a value associated with a pixel representing a portion of the image;
generating a tolerance buffer that includes a tolerance value that indicates a tolerance for the pixel;
generating a rendered buffer from the data associated with the image, the rendered buffer having a value associated with the pixel; and
determining whether the value of the render buffer that is associated with the pixel is outside the tolerance value for the pixel.

2. The computer-readable medium of claim 1, wherein the each buffer includes a value for each pixel representing the image and wherein each value is associated with a pixel representing the image.

3. The computer-readable medium of claim 2, wherein each value is part of a vector, the vector having other values that are associated with the pixel associated with the value.

4. The computer-readable medium of claim 3, wherein the values of each vector comprise color values associated with the pixel.

5. The computer-readable medium of claim 1, wherein determining whether the value of the render buffer that is associated with the pixel is outside the tolerance value for the pixel comprises computing a sum by subtracting the value of the rendered buffer from the value of the reference buffer.

6. The computer-readable medium of claim 5, wherein the value of the render buffer is outside the tolerance value if an absolute value of the sum is greater than the tolerance value.

7. The computer-readable medium of claim 1, wherein the reference buffer and the tolerance buffer are generated together.

8. The computer-readable medium of claim 1, further comprising displaying the image on a display from values included in the reference buffer.

9. The computer-readable medium of claim 1, further comprising applying a low-pass filter to a texture and applying the texture to the image.

10. The computer-readable medium of claim 1, further comprising modifying the value in the tolerance buffer to tolerate a flaw in a renderer.

11. The computer-readable medium of claim 10, wherein the flaw comprises an algorithmic flaw of the renderer.

12. The computer-readable medium of claim 11, wherein the algorithmic flaw only affects certain pixels rendered by the renderer.

13. The computer-readable medium of claim 12, wherein the tolerance buffer includes a value for each of the certain pixels and wherein each of the values for each of the certain pixels is adjusted to tolerate the flaw.

14. A method, comprising:
generating a reference buffer from data associated with an image representable by pixels, the reference buffer including a value associated with each pixel;
in conjunction with changing a value in the reference buffer, changing a corresponding value in a tolerance buffer, wherein each value in the tolerance buffer comprises a tolerance for rendering a pixel associated therewith.

15. The method of claim 14, wherein generating the reference buffer comprises rendering a sequence of objects associated with the image.

16. The method of claim 15, wherein if a value of the reference buffer is overwritten, then a corresponding value of the tolerance buffer is overwritten.

17. The method of claim 16, wherein the value of the reference buffer is overwritten when rendering a pixel of an object that is closer to a perspective than a corresponding pixel of an object that is already rendered.

18. The method of claim 16, wherein the value of the reference buffer is overwritten when rendering a pixel in a location upon which nothing from the image has been rendered previously.

19. The method of claim 16, wherein the value of the reference buffer is overwritten when rendering a pixel that is further from a perspective than a corresponding pixel of an object that is already rendered if the corresponding pixel is completely transparent.

20. The method of claim 15, wherein if a pixel value of the reference buffer is scaled by a percentage, then a corresponding value of the tolerance buffer is scaled by the percentage.

21. The method of claim 20, wherein the pixel value of the reference buffer is scaled by the percentage by a perspective-correct transformation.

22. The method of claim 20, wherein the pixel value of the reference buffer is scaled by the percentage through a blending of values of the pixel value and a pixel seen through the pixel corresponding to the pixel value.

23. The method of claim 22, wherein the pixel corresponding to the pixel value is partially transparent.

24. The method of claim 14, wherein each value is part of a vector that has other values that are also associated with the pixel associated with the value, wherein each vector is included in its corresponding buffer, and wherein each vector in the reference buffer corresponds with a vector in the tolerance buffer.

25. The method of claim 24, wherein if a vector of the reference buffer is overwritten, then a corresponding vector of the tolerance buffer is overwritten.

26. The method of claim 24, wherein if a vector of the reference buffer is scaled by a percentage, then a corresponding vector of the tolerance buffer is scaled by the percentage.

27. A system, comprising:
a reference renderer arranged to render a pixel representing a portion of a reference image based on data associated with the image; and
a tolerance buffer arranged to include a tolerance to determine correctness in rendering the pixel.

28. The system of claim 27, further comprising a rendering renderer arranged to render the pixel.

29. The system of claim 28, wherein the rendering renderer is deemed to have rendered the pixel correctly if a value associated with the pixel rendered by the renderer is within the tolerance from a corresponding value of the pixel rendered by the reference renderer.

30. The system of claim 27, further comprising multiple rendering renderers arranged to render the pixel, wherein each renderer is arranged to render the pixel according to an algorithm implemented by the renderer.

31. The system of claim 30, wherein an image produced by any rendering renderer is deemed correct if every pixel value in the image is within a corresponding tolerance from a corresponding value of a corresponding pixel in the image rendered by the reference renderer.
